(19) United States
(12) Patent Application Publication
(10) Pub. No.: US 2021/0080217 A1
(43) Pub. Date: Mar. 18, 2021

(54) A PORTABLE SUPPORT

(71) Applicant: Mark RICHARDS, Ballina, NSW (AU)

(72) Inventor: Mark RICHARDS, Ballina, NSW (AU)

(73) Assignee: David Gordon RICHARDS, Ballina, NSW (AU)

(21) Appl. No.: 16/961,425

(22) PCT Filed: Jan. 11, 2019
(86) PCT No.: PCT/AU2019/050012

§ 371 Date: Jul. 10, 2020

(30) Foreign Application Priority Data
Jan. 12, 2018 (AU) 2018900098
Jun. 5, 2018 (AU) 2018902011
Sep. 28, 2018 (AU) 2018903688

(51) Int. Cl. F41A 23/02; F16M 13/02; F16B 2/00; F16B 2/08; A01M 31/02

(52) U.S. Cl. CPC F41A 23/02; F16M 13/022; A01M 31/02; F16B 2/08; F16B 2/005

(57) ABSTRACT

A portable support including a mounting assembly configured to be releasably located relative to a surface or object, a body associated with a portion of the mounting assembly and extending at an angle therefrom and a substantially U-shaped or V-shaped yoke provided relative to the body.

### TECHNICAL FIELD

The present invention relates to a portable support and particularly to a portable support that is easily attachable to an object such as a tree or pole or similar, to support an object, such as a hunting rifle for example, relative thereto.

### BACKGROUND ART

A variety of portable supports are available for use by a hunter to aid in creating a stable rest for a rifle or similar.

Once such product is called a Triggerstick®. This device includes a number of telescopic members which are moveable relative to one another with a locking device actuated by a trigger provided at an upper end. Operation of the trigger can be accomplished using one hand which allows a person to extend the device to a desired height using one hand and to retract the device in a similar manner.

An upper portion of the device is provided with a Y-shaped rest or yoke for a rifle. The Y-shaped rest or yoke can rotate relative to the device to allow a user to pan using the device as a support for the rifle.

A detachable yoke system allows the Y-shaped yoke to be removed and an alternative mounting system such as for a camera or an optic device such as a spotting scope, can be attached quickly. The detachable yoke system includes an opening at the top of the Triggerstick which is associated with a laterally extending locking member.

Depression of a push button on the Triggerstick®, withdraws the locking member against a biasing spring. A lower portion of the yoke is provided with a complementary base with a locking shoulder or opening against or into which the locking member is received when in place, locking the yoke to the device. The complementary base with a locking shoulder or opening can be provided on other devices such as a mounting plate with a threaded member to allow attachment of a camera or optic device relative to the mounting plate.

Products such as the Triggerstick are available in a monopod (one leg) configuration as well as bipod and tripod configurations.

Devices such as these have a number of limitations including their size (even when reduced to the shortest length, they are still at least 30 cm in length, often longer) which means that hunters are forced to either carry them in a backpack or alternatively carry them in their hands whilst moving. If a hunter is carrying a rifle, this means that the hunter cannot carry the rifle in a ready position in two hands and must either drop or set up the support to use the rifle.

Additionally, set up time can be quite long to achieve a stable support. In addition, a stable support is difficult to achieve using the monopod and bipod configurations which still allow a larger degree of movement of the rifle.

Further, due to the nature of the device, the hunter will normally stand directly behind the device which means that the hunter will generally not be able to use the device to fire from cover, for example behind a tree for example.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a portable support, which may at least partially overcome at least one of the abovementioned disadvantages or provide the consumer with a useful or commercial choice.

With the foregoing in view, the present invention in one form, resides broadly in a portable support including a mounting assembly configured to be releasably located relative to a surface or object, a body associated with a portion of the mounting assembly and extending at an angle therefrom and an attachment portion provided relative to the body to allow releasable attachment of detachable implement relative thereto.

In another form, the present invention resides in a portable support a portable support including a mounting assembly configured to be releasably located relative to a surface or object, a body associated with a portion of the mounting assembly and extending at an angle therefrom and a substantially U-shaped or V-shaped rest provided relative to the body.

In yet another form, the invention resides in a portable support including a mounting assembly configured to be releasably located relative to a surface or object, a body associated with a portion of the mounting assembly and extending at an angle therefrom and an attachment portion provided relative to the body to allow attachment of implement relative thereto.

The portable support of the present invention may have any use although the bulk of the present discussion is directed toward the support being used in outdoor applications such as for hunting, photography and the like. Preferably, the portable support will be attached relative to a surface of an object in order to use the surface and/or object to support an item which would otherwise be held by a user embraced against the body of the user. Typically, the object will be a freestanding and self-supporting object such as a tree, pole or similar.

The support of the present invention is portable. In addition, it is preferred that the support is relatively small in order to fit into a waist-mounted rucksack, Fanny pack or bum bag for example. This will minimise and preferably eliminate the need for the user to have a backpack with shoulder straps which may interfere with the placement of a butt of a rifle or similar on the shoulder of the user. In addition, the small size of the support will preferably allow the user greater latitude for the user to have both hands available once the support is either stored or in position relative to an object, without the need to provide additional manual bracing of the support when in position.

The support will typically be attached relative to the object such that the support extends laterally to one side of the object. Due to this positioning when attached to the object, the user can use the support from cover behind the object, whilst still using the support. The support can be attached to the object on either side of the object and therefore, can provide support with the user under cover behind the object whether the user is right-handed or left-handed and using either their dominant hand or their off hand.

The portable support of the present invention includes a mounting assembly configured to be releasably located relative to a surface or object. Normally, the mounting assembly will include a mounting member to abut of at least face (a cover or similar may be provided) the surface of the object relative to which the portable support is attached. The mounting member may be planar or arcuate, however an arcuate mounting member is less preferred because the arc is less likely to suit a large number of tree sizes.

The mounting member will preferably be substantially rigid. In some embodiments, the mounting member may be flexible but it is preferred that at least a portion of the mounting member is rigid.

The mounting member will preferably be provided with a high friction abutment surface or portion over at least a part of the mounting member which faces the object relative to which the support is to be attached.

The high friction abutment surface or portion may be or include one or more protrusions, spikes or similar which are adapted to abut the surface of the object relative to which the support is to be attached in order to form a more secure engagement between the mounting member and the object. Preferably, any protrusions or spikes or similar will be provided in an array with multiple protrusions or spikes or similar provided. Normally, the array will be a regular array. The one or more protrusions, spikes or similar may be formed of any material but will typically be or include a metal or plastic material. In a particularly preferred embodiment, a number of spikes will be provided extending from the abutment surface of the mounting member in order to engage with the surface of the object relative to which the support is to be attached and to be maintained there by pressure or partial penetration into the surface of the object.

The mounting member may include one or more structures on the facing side of the mounting member to the surface of the object relative to which the portable support is attached which allow the mounting member to be positioned relative to mounting structures on the object. In a preferred embodiment, one or more mounting openings may be provided which can then engage with dowels or similar provided on (and extending from) the object. The provision of such structures may allow the support to be positioned in a required or desired position relative to the object with precision even once removed. This may be useful if the support is used for the mounting of surveying equipment for example. An opposite configuration (extensions from the surface of the mounting member to engage with openings on the object) may be used but is less preferred.

The mounting assembly of the support of the preferred embodiment will also preferably include a length adjustable member, typically a strap or similar can be wrapped about the object and tightened in order to apply a clamping force to the mounting member in order to clamp the mounting member to the object. Preferably, the length adjustable member will be flexible. Typically, the length adjustable member will be associated with the mounting member or the body in order to apply the clamping force.

In one preferred embodiment, the length adjustable member will be or include a strap associated with the mounting member, the strap having a pair of free ends with a clip or buckle or similar assembly provided at the respective free ends in order to allow the strap to be opened to pass about an object and then clipped or buckled about the object. Preferably, the strap will be length adjustable in order to be tightened once clipped or buckled about the object. Tightening the length adjustable strap once clipped or buckled about the object will preferably apply pressure to the preferred one or more protrusions, spikes or similar on the mounting member in order to engage in the one or more protrusions spikes or similar with the surface of the object.

Preferably, the strap will be formed from a woven material for strength and abrasion resistance, preferably a polyester or similar material.

The clip or buckle or similar may have any form but will preferably be manufactured from a strong but lightweight material. A simple snapfit clip having a male portion and a female portion associated with respective ends of the preferred strap is a particularly preferred option.

An alternative length adjustable member may be or include a Velcro or similar as this will allow simple attachment and detachment from the object. However, in the context of outdoor use, it is easy for Velcro to become fouled by use, particularly by leaves or similar which get caught on the Velcro portions and affect the attachment of one Velcro portion to the other Velcro portion. For this reason, Velcro is less preferred than a strap with a buckle or clip.

The length adjustable member will typically be provided about an opposite side of the mounting member to the side on which the one or more protrusions, spikes or similar are provided in order to provide force on the opposite side to clamp the one or more protrusions, spikes or similar to the object.

In another embodiment, the mounting assembly may include a pole mount configured to allow mounting of the support relative to a pole having a smaller diameter. In one form, one or more U-shaped members or fasteners may be provided associated with the mounting member of the mounting assembly. In a particularly preferred embodiment, the mounting plate may be provided with a number of holes therethrough, typically at an upper portion and/or at a lower portion and at least one and preferably a pair of U-bolts may be provided to allow the mounting assembly to be mounted more securely and/or more permanently using the U-bolts.

The support of the present invention also includes a body associated with a portion of the mounting assembly and extending at an angle therefrom. The body will typically be associated with the mounting member of the mounting assembly and preferably, on the opposite side of the mounting member to the abutment surface or one or more protrusions, spikes or similar. The body will typically be mounted directly to the mounting member. The body may be mounted to the mounting member temporarily to allow some disassembly, or permanently in order to allow the support to be used more simply, without requiring assembly when it is desired to be used.

It is preferred that the body and the mounting member be integrally formed with one another for example, in a one-piece construction or permanently attached together. Alternatively, the body and the mounting member may be separable from one another and attachable to allow detachment to reduce the size of the support. Any engagement mechanism may be used if the body and the mounting member are separable for example a groove provided in one of the body or mounting member and a corresponding flange on the other to allow quick and easy attachment and detachment of the body and mounting member.

The body may be pivotally mounted to the mounting member, for example mounted about hinge or pivot point in order to allow the rotation of the body relative to the mounting member. Any hinge or pivot point will preferably allow rotation or movement of the body in a plane which is substantially perpendicular to that of the mounting member and/or substantially parallel to the mounting member.

The body may be formed from a number of portions attached to or relative to one another. In one form, the portions are pivotally or rotatably attached relative to one another allowing the body to articulate. Normally, a locking mechanism is provided allowing a user to at least temporarily fix the positions of any one or more portions of the body relative to any one or more other portions of the body.

The body preferably extends substantially perpendicularly to the plane of the mounting member.

The body preferably extends from the mounting member such that a free end of the body is spaced apart from the plane of the mounting member. In a preferred embodiment, the body may be length adjustable, for example, having one or more portions which telescope relative to each other in order to change the length of the body in order to change the spacing between the free end of the body and the plane of the mounting member.

The support of the present invention includes a substantially U-shaped or V-shaped rest provided relative to the body, preferably configured for rotation relative to the body.

The substantially U-shaped or V-shaped rest or yoke is preferably formed from a substantially Y-shaped portion with a U-shaped or V-shaped rest portion and a downcomer portion extending from the rest portion. The downcomer portion will preferably be substantially linear. In use, the substantially linear downcomer portion will be received at least partially into an opening provided in the body which will both attach the rest portion relative to the body and allow rotation of the rest portion relative to the body. It is preferred that the substantially Y-shaped portion is of single piece construction.

Any method of construction or material of construction can be used but a preferred embodiment includes a core of material, preferably metal, which is then coated with a slightly resilient material such as rubber or a substitute for example, plastic. In an alternate form, the rest or yoke may be manufactured from a plastic material or a rubber or substitute for example.

A plastic rest or yoke may be provided with one or more rubber or similar portions. In a preferred embodiment, the substantially U-shaped or V-shaped rest or yoke will have a pair of arms which extend upwardly away from the body relative to which the substantially U-shaped or V-shaped rest or yoke is mounted. An inner or facing surface or portion of each of the arms may have a resilient configuration, in one form, a series of resilient members spaced apart from one another over a portion of the height of each of the arms for shock absorption and to adjust to the different dimensions of the stocks of different rifles.

As mentioned above, an opening will normally be provided in the body for receiving the downcomer portion to attach the rest portion and allow the rotation.

Preferably, the rest or yoke is spaced from the mounting member in order to separate the rest or yoke from the object relative to which the support will be attached in use. Typically, the rest or yoke is sized to allow an object to be placed within the substantially U-shaped rest or yoke and to allow some movement relative to the rest but to limit large movements.

The rest or yoke may be removable from the body in order to be interchangeable with other items suited for other purposes but using the same attachment point as the rest or yoke. For example, the preferred opening on the body may be provided with a snap lock system in order to allow a portion of the rest or yoke to releasably engage with the body and to allow other items to be attached using the same preferred opening and to provide tactile and/or audible feedback of the engagement of the items with the body.

In an alternative form, the support may include an attachment portion provided relative to the body to allow releasable attachment of detachable implement relative thereto. The attachment portion may be very simple for example a surface upon which a resilient pad or similar may be located. The attachment portion and/or the detachable implement may be articulated or pivotable relative to the body.

The attachment portion may have any form but will typically include an opening provided into the body. The opening may be provided with a snaplock system in order to allow releasable attachment but to provide tactile and/or audible feedback of engagement.

Each detachable implement will typically be provided with an appropriate engagement assembly to engage with the opening provided in the body. For example, a downcomer may be provided on the detachable implement in order to be engaged with the opening in the body. Normally, any downcomer will be rigid in typically, a material such as plastic or metal will be used. The downcomer may be elongate. The downcomer may have a circumferential groove or shoulder provided thereon in order to engage with the snaplock assembly provided in the opening on the body.

Alternatively, the body may be provided with a fitting in order to attach implements thereto. For example, the body may be provided with a detachable yoke system allows the Y-shaped yoke to be removed and an alternative mounting system such as for a camera or optic device such as a spotting scope, or surveying equipment for example, to be attached quickly. A preferred detachable yoke system includes an opening on the body which is associated with a laterally extending locking member.

Depression of a push button on the body may withdraw the locking member against a biasing element such as a spring. A lower portion of the yoke (and any detachable implement) is provided with a complementary base with a locking shoulder or opening against or into which the locking member is received when in place, locking the yoke (and any detachable implements) to the body. The complementary base with a locking shoulder or opening can be provided on other devices such as a mounting plate with a threaded member extending upwardly to allow attachment of a camera or optic device relative to the mounting plate.

A configuration which is opposite could also be used, that is where the body is provided with a protrusion and the item to be attached provided with a corresponding opening or depression. A locking member may be provided in association with the protrusion (extending laterally therefrom and biased into the extended position) and a depressible button provided on the item which when depressed, forces the locking member to disengage from the periphery of the opening or depression in the item, allowing removal.

A rotation assembly may be provided on the detachable yoke to allow rotation of the yoke relative to the body when attached using a locking member as outlined above.

In one preferred form, the portable support of the present invention may include a cover assembly, preferably mounted to or relative to the mounting member having the preferred protrusions, spikes or similar in order to releasably cover the protrusions, spikes or similar if required.

At least one cover member may be provided, preferably attached to, and typically hinged relative to the mounting member. A latch with a release mechanism is typically associated with the cover assembly to allow a user to release the cover member from the closed condition, preferably with only one hand. Normally the hinge will be provided at a lower side of the cover member to allow gravity to move the cover member to the open condition.

In an alternative embodiment, a cover assembly may be provided that is removable, for example, a foam cover layer which temporarily covers the protrusions, spikes or similar and can be removed prior to use.

Preferably, a side of the cover member that is oriented towards the protrusions, spikes or similar when closed is provided with a corresponding number of guides formations or similar to at least partially receive each of the protrusions, spikes or similar when the cover member is closed.

An opposite or outer surface of the cover member is preferably provided with a high friction portion or layer. Preferably, a resilient material such as EVA foam or similar is used as this material will provide a soft surface for abutment and also forgiveness to allow for a variety of different shapes.

As mentioned above, the body may be detachable from the mounting assembly. In one preferred configuration, the body is provided with an attachment portion at one end thereof to engage with corresponding receiving portion on the mounting plate or assembly. Of course, the configuration can be reversed with the attachment portion on the mounting plate or assembly and the corresponding receiving portion on the body.

According to a preferred embodiment, the attachment portion is generally V-shaped with a narrower lower portion and a wider upper portion. The receiver portion is normally correspondingly shaped so that the attachment portion can slide into the receiver portion. A locking mechanism may be provided to releasably lock the attachment portion into the receiver portion against accidental but not determined separation.

As mentioned, the protrusions, spikes or similar may be provided in different numbers. Provision may be made for a number of protrusions, spikes or similar to be mounted to the mounting plate but not all need to be provided (ie, some could be omitted). Further, protrusions, spikes or similar may be provided in different lengths if required as this could be used to create a spike bed which is arcuate by providing longer protrusions, spikes or similar on the outer sides and smaller protrusions, spikes or similar toward the centre of the mounting plate.

In a preferred embodiment, the device may include a slide plate which is preferably removably attachable relative to the body. A threaded fastener or similar may be provided to extend through an opening in the slide plate and into a correspondingly threaded opening in the body. A correspondingly threaded opening may be provided in one or both sides of the body or a single opening may be provided extending through the body and threaded in opposite directions on opposed ends to allow the slide plate to be removably mounted on either side of the body at the preference of the user.

Any other appropriate mechanism for removable attachment may be used instead of the threaded fastener may be used such as for example a clip or snap-fit. In yet another configuration, the slide plate may not be removable and may be permanently mounted relative to the body.

One or more and preferably a number of engagement teeth may be provided between the slide plate and the body to allow the slide plate to be temporarily retained relative to the body in any one or more of a number of orientations. Where a threaded fastener is used, the threaded fastener can be tightened to fix the slide plate relative to the body in a desired orientation using the engagement teeth.

The slide plate will preferably correspond in shape to the receiver portion provided on the mounting plate so that the slide plate can slide into the receiver portion for storage or when the user is on the move which will locate the body close to the user's body rather than extending transversely from the mounting plate in the use condition.

A level indicator or level device may be provided relative to the support, typically relative to the body in order to determine the level of the body and/or level the body. A simple device such as a spirit level could be incorporated or a more complex device such as a digital readout or similar could be used.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an axonometric view of a portable support according to a preferred embodiment of the present invention.

FIG. 2 is a view from the front of the portable support illustrated I FIG. 1.

FIG. 3 is a view from the rear of the portable support illustrated I FIG. 1.

FIG. 4 is a photograph showing the portable support illustrated in FIG. 1 in use attached to a tree and supporting a rifle.

FIG. 5 is an isometric view of a portable support according to another preferred embodiment of the present invention.

FIG. 6 is an axonometric view of the portable support illustrated in FIG. 5 with the cover slightly separated from the rear of the mounting plate.

FIG. 7 is an axonometric view of the able support illustrated in FIG. 5 with the cover opened.

FIG. 8 is a view from above of the configuration illustrated in FIG. 7.

FIG. 9 is a view from above of the configuration illustrated in FIG. 5.

FIG. 10 is an isometric exploded view of the portable support illustrated in FIG. 5.

FIG. 11 is an isometric exploded view of the alternative adaptors that could be used with the portable support illustrated in FIG. 5.

FIG. 12 is an isometric view of a further preferred embodiment of the present invention.

FIG. 13 is an isometric exploded view of the embodiment illustrated in FIG. 12.

FIG. 14 is an alternative view of the embodiment illustrated in FIG. 12 with the foam cover removed.

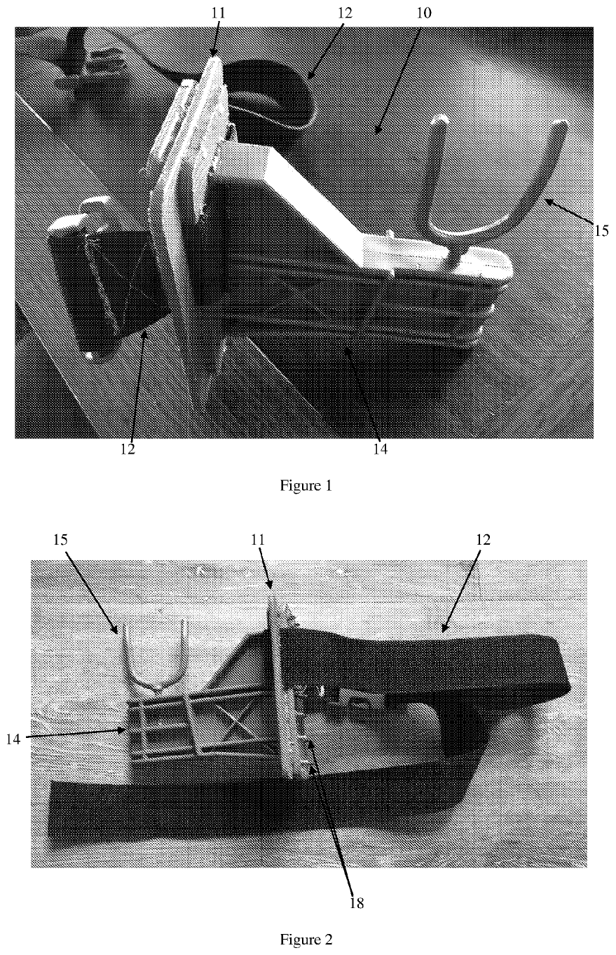

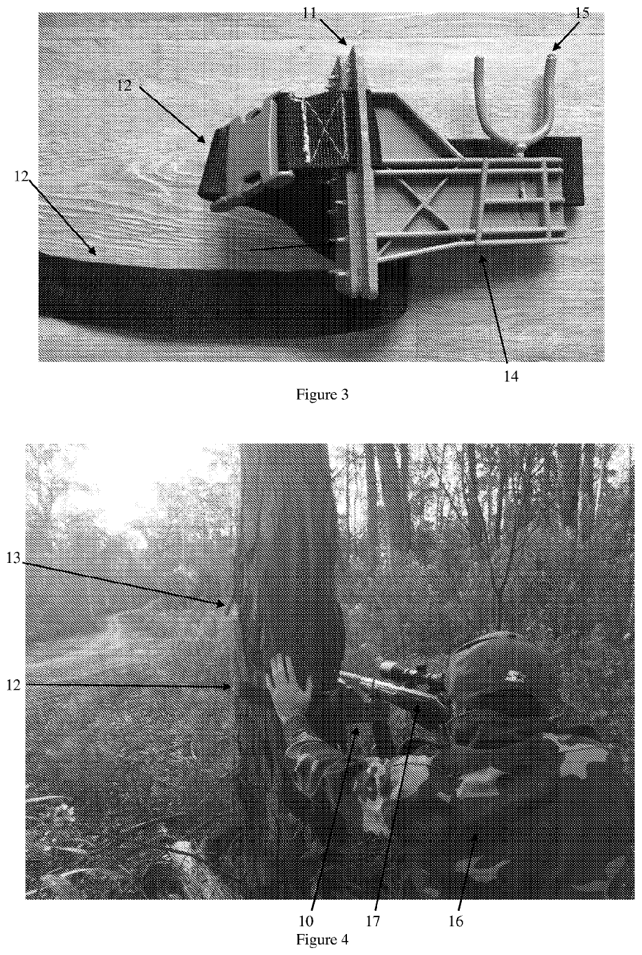

### DESCRIPTION OF EMBODIMENTS

According to a particularly preferred embodiment of the present invention, a portable support 10 is provided.

The portable support 10 illustrated in the accompanying Figures includes a mounting assembly including a mounting plate 11 and a strap 12 configured to releasably locate the portable support 10 relative to a surface or object such as a tree 13 as illustrated in FIG. 4. The portable support 10 also includes a body 14 associated with the mounting plate 11 and extending at an angle therefrom and a substantially U-shaped yoke 15 provided relative to the body 14, preferably configured for rotation relative to the body 14.

The portable support of the present invention may have any use although the bulk of the present discussion is directed toward the support being used in outdoor applications such as for hunting, photography and the like. As shown in FIG. 4, the portable support 10 will be attached relative to an object in order to use the surface and/or object to support an item which would otherwise be held by a user embraced against the body of the user, such as a hunting rifle, as shown in FIG. 4.

The support 10 of the present invention is portable. In addition, it is preferred that the support 10 is relatively small in order to fit into a waist-mounted rucksack, Fanny pack or bum bag for example. This will minimise and preferably eliminate the need for the user to have a backpack with shoulder straps which may interfere with the placement of a butt of a rifle or similar on the shoulder of the user. In addition, the small size of the support 10 will preferably allow the user greater latitude for the user to have both hands available once the support is either stored or in position relative to an object without the need to provide additional manual bracing of the support 10 when in position.

As shown in FIG. 4, the support 10 is attached relative to the tree 13 such that the support 10 extends laterally to one side of the tree 13. Due to this positioning when attached to the tree 13, the user 16 can use the support 10 from cover behind the tree whilst still using the support 10 to brace the rifle 17. The support 10 can be attached to the tree 13 on either side of the tree 13 and therefore, can provide support whilst the user 16 remains under cover behind the tree 13 whether the user 16 is right-handed or left-handed and using either their dominant hand or their off hand to aim and fire the rifle 17.

Normally, the mounting assembly includes a mounting member or plate 11 to abut the surface of the object relative to which the portable support 10 is attached. The mounting member illustrated in the Figures is planar plate 11.

The mounting plate 11 is substantially rigid and one portion or surface of the mounting plate is provided with a high friction abutment surface or portion over at least a part of the mounting plate which faces the object relative to which the support 10 is to be attached.

In the illustrated embodiment, the high friction abutment surface includes a number of spikes 18 which are adapted to abut and preferably engage the surface of the tree 13 relative to which the support 10 is attached in order to form a more secure engagement between the support 10 and the tree 13. The spikes 18 are provided in an array with multiple spikes provided in a regular array. The spikes of the preferred embodiment are a metal or plastic material. In the illustrated preferred embodiment, a number of spikes 18 are provided extending from the abutment surface of the mounting plate 11 in order to engage with the surface of the tree relative to which the support 10 is attached and are maintained there by pressure or partial penetration into the surface of the tree caused by tightening the strap 12.

The strap 12 is wrapped about the tree 13 and tightened in order to apply a clamping force to the mounting plate 11 in order to clamp the mounting plate 11 and thereby the support 10, to the tree. Preferably, the strap 12 is length adjustable and flexible attached to the support 10 through the body 14 and about the rear of the mounting plate 11 in order to apply the clamping force.

The strap 12 has a pair of free ends with a clip assembly provided at the respective free ends in order to allow the strap 12 to be opened to pass about the tree and then clipped about the tree 13. Tightening the length adjustable strap 12 once clipped about the tree 13 applies pressure to the spikes 18 on the mounting plate 11 ember in order to engage the spikes 18 with the surface of the tree 13.

In the illustrated embodiment, the strap 12 is formed from a woven material for strength and abrasion resistance, preferably a polyester or similar material.

The clip may have any form but will preferably be manufactured from a strong but lightweight material. A simple snap fit clip having a male portion and a female portion associated with respective ends of the strap 12 is a particularly preferred option.

The body 14 is associated with the mounting plate 11 on the opposite side of the mounting plate 11 to the spikes 18. The body 14 is mounted directly to the mounting plate 11. It is preferred that the body and the mounting member be integrally formed with one another for example, in a one-piece construction or attached thereto permanently as illustrated. The body 14 extends substantially perpendicularly to the plane of the mounting plate 11.

The body 14 extends from the mounting plate 11 such that a free end of the body 14 is spaced from the plane of the mounting plate 11.

The substantially U-shaped rest or yoke 15 of the illustrated embodiment formed from a substantially Y-shaped portion with a U-shaped yoke portion and a downcomer portion extending from the yoke portion. The downcomer portion is substantially linear and is received at least partially into an opening provided in the body 14 which will both attach the yoke 15 relative to the body 14 and allow rotation of the yoke 15 relative to the body 14.

Any method of construction or material of construction can be used but the preferred embodiment includes a shaped core of metal material which is then coated with a slightly resilient material such as rubber or a substitute for example, plastic.

As mentioned above, an opening will normally be provided in the body 14 for receiving the downcomer portion to attach the yoke 15 and allow the rotation.

Preferably, the rest or yoke 15 is spaced from the mounting plate 11 in order to separate the yoke 15 from the tree relative to which the support 10 is attached in use. Typically, the rest or yoke 15 is sized to allow an object, such as the rifle 17 to be placed within the substantially U-shaped yoke 15 and to allow some movement relative to the yoke 15 but to limit large movements. This will allow a user 16 to support the rifle 17 on the support 10 of the preferred embodiment which is attached to the tree 13.

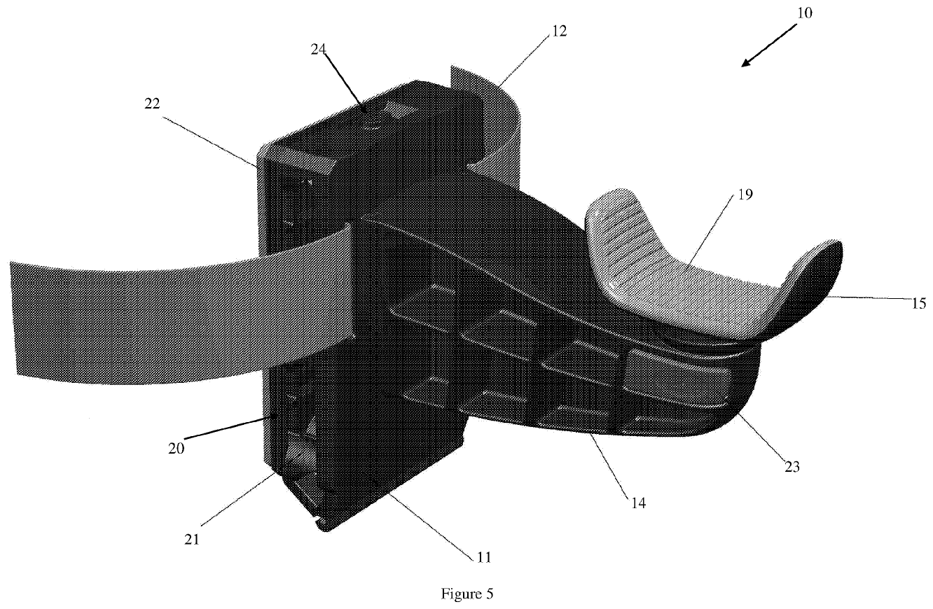

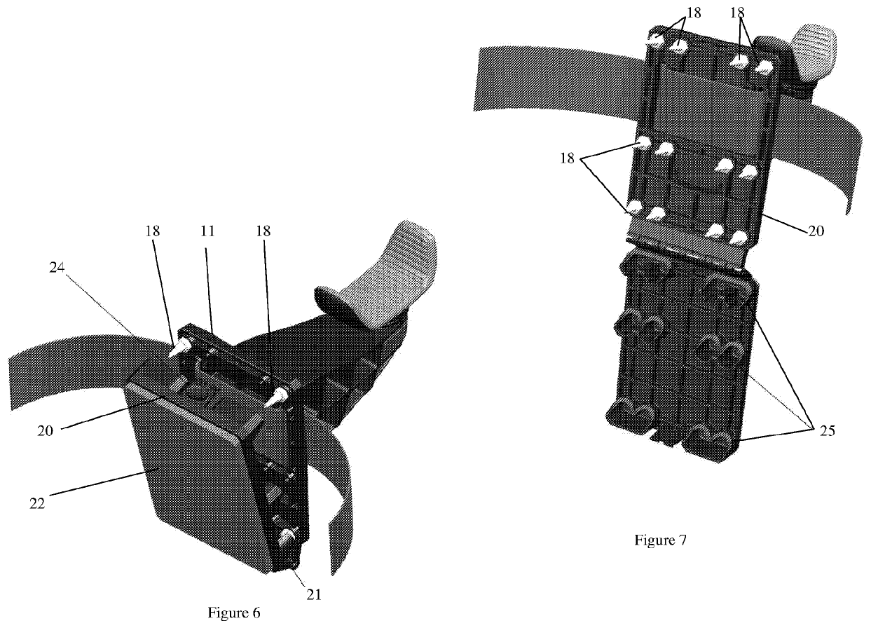

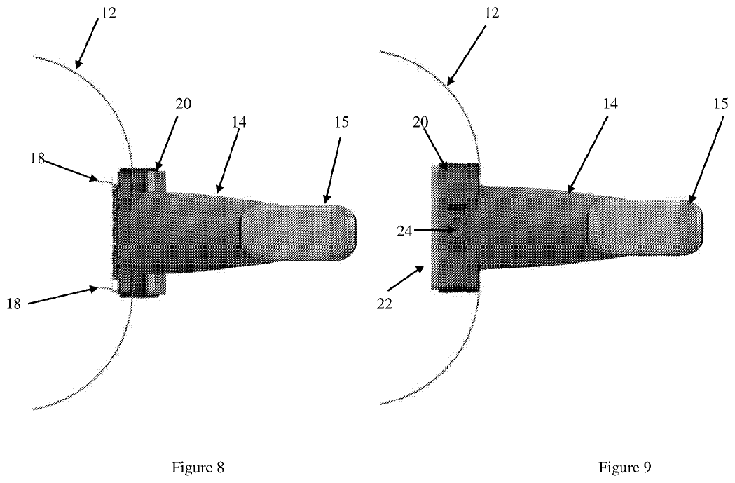

In the form illustrated in FIGS. 5 to 11, the portable support 10 includes a support body 14 releasably attached to a mounting plate 11 with a strap 12 attached and a yoke 15 with an overmoulded rubber grip 19. A cover assembly including a cover plate 20 is mounted to the mounting member using a hinge 21 to releasably cover the spikes 18 on the mounting plate 11 if required.

A latch with a release button 24 is typically associated with the cover assembly to allow a user to release the cover plate 20 from the closed condition (shown in FIG. 5), preferably with only one hand. Normally the hinge 21 is provided at a lower side of the cover plate 20 to allow gravity to move the cover plate 20 to the open condition once released.

The side of the cover plate 20 that is oriented towards the spikes 18 when closed, is provided with a corresponding number of guide formations 25 to at least partially receive each of the spikes 18 when the cover plate 20 is closed. The guide formations also add mechanical strength to the hinge 21 and the cover plate 20. The spikes 18 are shown attached to the mounting plate with washers 150 between the spike and the mounting plate.

An outer surface of the cover plate 20 is provided with a high friction layer 22, preferably of a resilient material such as EVA foam or similar as this material will provide a soft surface for abutment and also forgiveness to allow for a variety of different shapes.

As mentioned above, the body 14 may be detachable from the mounting assembly. In one preferred configuration shown in FIG. 10, the body 14 is provided with an attachment portion 26 at one end thereof to engage with corresponding receiving portion 27 on the mounting plate 11. The attachment portion 26 illustrated in FIG. 10 is generally V-shaped with a narrower lower portion and a wider upper portion. The receiver portion 27 is normally correspondingly shaped so that the attachment portion 26 can be slide into the receiver portion 27.

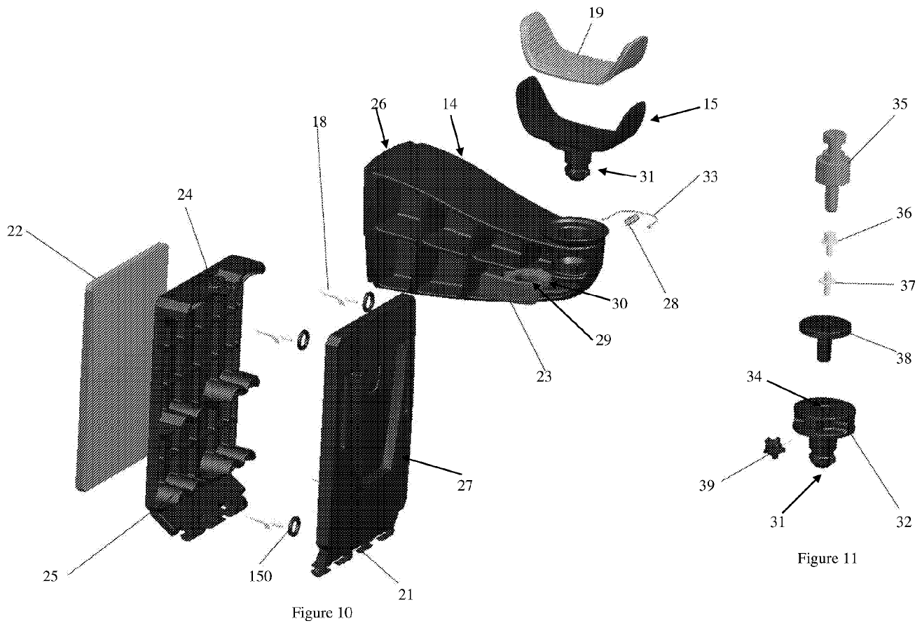

Also illustrated in FIG. 10 is a preferred form of releasable yoke 15. As shown a push button 23 release is provided in the body 14 which is associated with a spring 28 to bias the push button 23 outwardly. The push button 23 has an opening 29 provided through a locking portion 30 into which the neck 31 of the yoke 15 or adapter 32 is located. The neck 31 of the yoke 15 or adapter 32 has a recess or opening into at least one side thereof (a circumferential groove or notch is shown in FIGS. 10 and 11) and a portion of the periphery of the opening 29 engages the recess or opening when the push button 23 is biased outwardly. A spring retainer 33 is provided to hold the push button 23 in the body 14 and the spring against the body 14. Depression of the push button 23 moves the periphery of the opening 29 out of the recess or opening against the bias of the spring 28 allowing insertion and release of the neck 31 of the yoke 15 or adapter 32 from the body 14 and when released, the button 23 is driven outwardly by the spring 28 into a locking position.

A general adapter 32 is provided to allow for various types of specific adapters to be engaged with the body 14. The adapter 32 has a neck 31 of the same configuration as the yoke 15. The general adapter 32 has an opening for receiving insert portions of other adapters specific to purpose such as a camera adapter 35, or threaded adapters 36, 37 for a scope or for other devices. A mini adapter/converter 38 may be provided to allow for attachment of different types of threaded adapters. A transversely extending locking spindle 39 may be provided. The provision of the adapter configurations may allow a user to mount a general adapter 32 to any one or more alternative pieces of field kit for quick and easy swapping of these devices with the yoke.

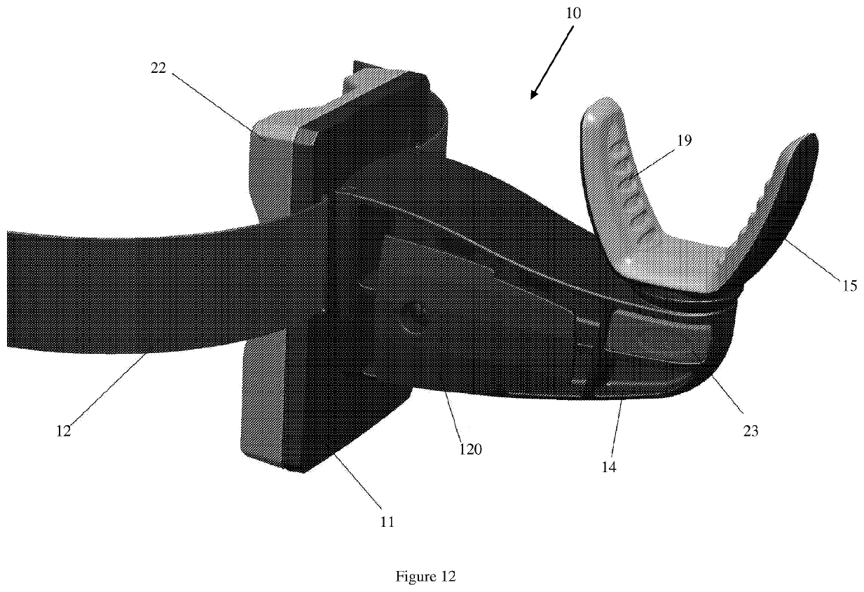

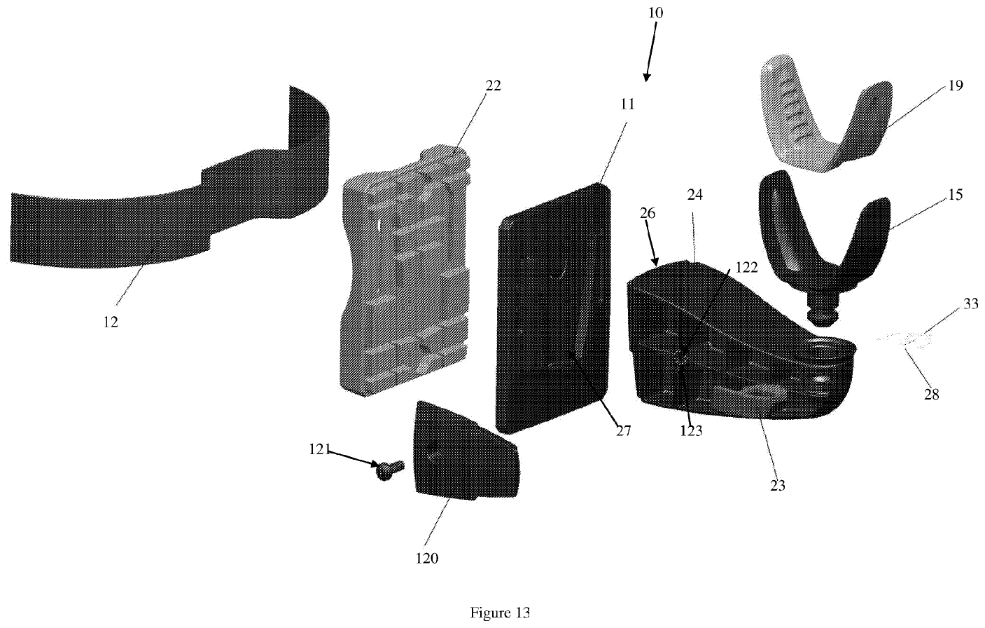

The configuration illustrated in FIGS. 12 and 13 is similar to that illustrated in FIGS. 5 to 10 with similar reference numbers referring to similar features. The main difference between the configuration illustrated in FIGS. 12 and 13 from that illustrated in FIGS. 5 to 10 is the provision of the high friction layer 22, typically of EVA foam or similar directly to the rear of the mounting plate 11 without any spikes, protrusions or similar provided. The provision of the high friction layer 22 of EVA foam or similar will allow the device to be mounted relative to an object such as a tree or pole with the resilient EVA foam adjusting for any inconsistencies in the shape of the object and provide a secure mount. The removal of the spikes in this embodiment also lightens the device considerably.

Also shown in FIGS. 12 and 13 is a slide plate 120 which is attachable relative to the body 14 through the use of a threaded fastener 121 through an opening in the slide plate and into a correspondingly threaded opening 122 in the body 14. A correspondingly threaded opening is provided in both sides of the body 14 (or a single opening may be provided extending through the body 14 and threaded in opposite directions on opposed ends) to allow the slide plate to be removably mounted on either side of the body 14 at the preference of the user.

The slide plate 120 corresponds in shape to the receiver portion 27 provided on the mounting plate 11 so that the slide plate can slide into the receiver portion 27 for storage or when the user is on the move which will locate the body 14 close to the user's body rather than extending transversely from the mounting plate in the use condition.

A number of engagement teeth are provided between the slide plate and the body surrounding the opening 122 to allow the slide plate 120 to be temporarily retained relative to the body in any one or more of a number of orientations. Where a threaded fastener 121 is used, the threaded fastener 121 can be tightened to fix the slide plate 120 relative to the body in a desired orientation using the engagement teeth.

The device can then be worn about the user's waist using strap 12 or over the shoulder on either side of the user's body as desired when not being used.

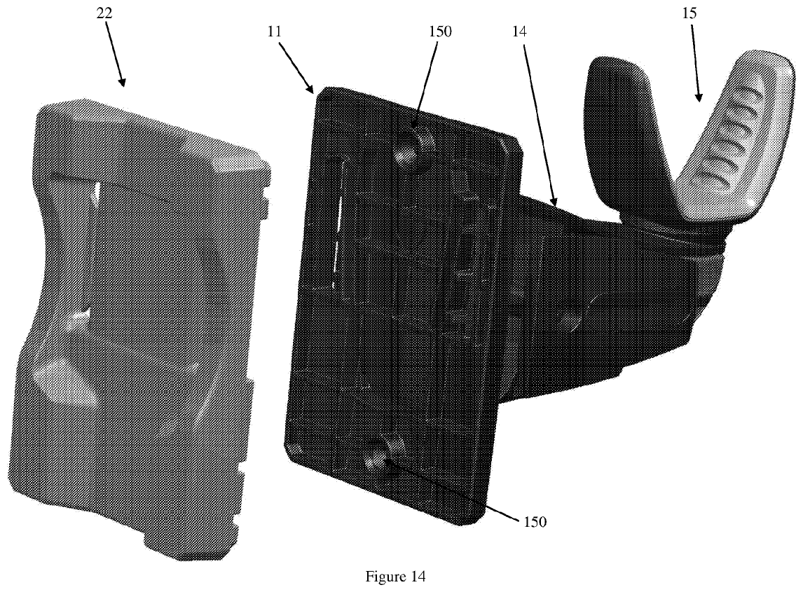

FIG. 14 shows the facing side of the mounting plate 14 provided with a pair of mounting openings 150 which can then engage with dowels or similar provided on (and extending from) the object. In use, the high friction EVA foam layer 22 or cover can be removed from the mounting plate 14 to expose the mounting openings 122 which can then engage with dowels or similar provided on (and extending from) the object to position the support 10 in a required or desired position relative to the object with precision.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A portable support including a mounting assembly configured to be releasably located relative to a surface or object, a body associated with a portion of the mounting assembly and extending at an angle therefrom and an attachment portion provided relative to the body to allow attachment of implement relative thereto.

2. The portable support as claimed in claim wherein the mounting assembly includes a mounting member to abut the surface of the object relative to which the portable support is attached.

3. The portable support as claimed in claim 2 wherein the mounting member is provided with a high friction abutment surface or portion over at least a part of the mounting member which faces the object relative to which the support is to be attached.

4. The portable support as claimed in claim 3 wherein the high friction abutment surface or portion is or includes one or more protrusions adapted to abut the surface or object relative.

5. The portable support as claimed in claim 3 wherein the high friction abutment surface or portion is or includes a resilient portion.

6. The portable support as claimed in claim 1 wherein the mounting assembly includes a length adjustable member to be wrapped about the object and tightened in order to apply a clamping force to the mounting member in order to clamp the mounting member to the surface or object.

7. The portable support as claimed in claim 1 wherein the mounting assembly includes one or more U-shaped members or fasteners associated with the mounting member in order to apply a clamping force to the mounting member in order to clamp the mounting member to the surface or object.

8. The portable support as claimed in claim 1 wherein the body is detachably mounted to the mounting member.

9. The portable support as claimed in claim 8 wherein a groove is provided in one of the body or mounting member and a corresponding flange on the other of the body or mounting member to allow quick and easy attachment and detachment of the body and mounting member.

10. The portable support as claimed in claim 1 wherein the body is pivotally mounted to the mounting member to allow the rotation of the body relative to the mounting member.

11. The portable support as claimed in claim 1 wherein the body extends substantially perpendicularly to the mounting member.

12. The portable support as claimed in claim 1 wherein the body extends from the mounting member such that a free end of the body is spaced apart from the mounting member.

13. The portable support as claimed in claim 1 including a substantially U-shaped or V-shaped rest provided relative to the body.

14. The portable support as claimed in claim 13 wherein an opening is provided in the body for receiving a downcomer portion associated with the U-shaped or V-shaped rest to attach the U-shaped or V-shaped rest and allow the rotation of the U-shaped or V-shaped rest relative to the body.

15. The portable support as claimed in claim 13 wherein U-shaped or V-shaped rest is releasably attachable from the body in order to be interchangeable with other items suited for other purposes but using the opening as an attachment point.

16. The portable support as claimed in claim 1 including an attachment portion provided relative to the body to allow releasable attachment of a detachable implement relative thereto.

17. The portable support as claimed in claim 16 wherein the attachment portion includes one of the following: an opening provided into the body; an extension provided from the body; an adapter configured to attach to the body and to attach the detachable implement relative thereto.

18. (canceled)

19. (canceled)

20. The portable support as claimed in claim 8 wherein the body is provided with an attachment portion at one end thereof to engage with corresponding receiving portion on the mounting plate or assembly for detachable mounting of the body relative to the mounting assembly.

21. The portable support as claimed in claim 20 wherein the attachment portion is substantially V-shaped with a narrower lower portion and a wider upper portion and the receiving portion is correspondingly shaped so that the attachment portion can slide into the receiving portion.

22. The portable support as claimed in claim 21 further including a slide plate which is removably attachable relative to the body corresponding in shape to the receiving portion provided on the mounting plate so that the slide plate can slide into the receiving portion for storage.

23. A portable support including a mounting assembly configured to be releasably located relative to a surface or object, a body associated with a portion of the mounting assembly and extending at an angle therefrom and a substantially U-shaped or V-shaped yoke provided relative to the body.
